(19) United States
(12) Patent Application Publication
(10) Pub. No.: US 2020/0042266 A1
(43) Pub. Date: Feb. 6, 2020

(54) FLEXIBLE SCREEN SOUND BOX AND METHOD FOR CONTROLLING THE SAME

(71) Applicant: Yungu (Gu'an) Technology Co., Ltd., Langfang (CN)

(72) Inventors: Fu LIAO, Langfang (CN); Qi SHAN, Langfang (CN); Liwei DING, Langfang (CN)

(21) Appl. No.: 16/653,212

(22) Filed: Oct. 15, 2019

Related U.S. Application Data
(63) Continuation of application No. PCT/CN2018/088425, filed on May 25, 2018.

(30) Foreign Application Priority Data
Mar. 29, 2018 (CN) 201810272995.5

(51) Int. Cl. G06F 3/147; H04R 1/02; G06F 3/0488; G06F 3/0484; G09G 3/3225

(52) U.S. Cl. CPC G06F 3/147; H04R 1/025; G06F 3/0488; G06F 3/0484; G09G 2354/00; G09G 3/3225; H04R 2499/15; G09G 2380/02; H04R 1/023

(57) ABSTRACT

The flexible screen sound box includes a sound box body and a flexible screen. The sound box body includes a control module (or can be called “a control circuit”) connected with the flexible screen. The flexible screen is provided on an outer surface of the sound box body and includes at least one sub-flexible screen configured to receive a control instruction of the control module and display rhythm information based on the control instruction. The flexible screen is provided on the outer surface of the sound box, so that the at least one sub-flexible screen of a sound box displays different pictures or notes with changes of rhythm, thereby arousing a purchase desire of young consumers and satisfying requirements of the young consumers for fashion and beauty.

### CROSS-REFERENCE TO RELATED APPLICATIONS

This application is a continuation of International Application No. PCT/CN2018/088425 filed on May 25, 2018, which claims priority to Chinese patent application No. 201810272995.5 filed on Mar. 29, 2018. Both applications are incorporated herein by reference in their entireties.

### TECHNICAL FIELD

The present disclosure relates to the field of sound box technologies, in particular to a flexible screen sound box and a method for controlling the same.

### BACKGROUND

With the progress of technologies and the rapid development of flexible screens, people pursue a life of higher quality. While choosing sound boxes, young consumers not only require good sound qualities, but also require fashion and beauty. Those existing sound boxes have a single function and mostly cannot display music rhythm. In addition, although some sound boxes are equipped with display screens, the display screens can only be flat screens, which restricts appearance design of the sound boxes, thereby causing inability to arouse a purchase desire of young consumers and cannot satisfying requirements of the young consumers for the fashion and beauty.

### SUMMARY

In view of this, embodiments of the present disclosure provide a flexible screen sound box, which is capable of displaying different pictures or notes with changes of rhythm, and a method for controlling the same, thereby arousing a purchase desire of young consumers and satisfying requirements of the young consumers for fashion and beauty.

According to one aspect of the present disclosure, a flexible screen sound box is provided, including a sound box body and a flexible screen. The sound box body includes a control module connected with the flexible screen. The flexible screen is provided on an outer surface of the sound box body and includes at least one sub-flexible screen configured to receive a control instruction of the control module and display rhythm information based on the control instruction.

In an embodiment of the present disclosure, the at least one sub-flexible screen receives the control instruction from the control module and displays pictures or notes that change with rhythm based on the control instruction.

In an embodiment of the present disclosure, the at least one sub-flexible screen includes a first sub-flexible screen and a second sub-flexible screen. The first sub-flexible screen is provided on a portion of the outer surface of the sound box body, the second sub-flexible screen is provided on another portion of the outer surface of the sound box body, and the control module controls the first sub-flexible screen and the second sub-flexible screen, respectively.

In an embodiment of the present disclosure, the sound box body includes a first sound box housing and a second sound box housing.

In an embodiment of the present disclosure, each sub-flexible screen of the at least one sub-flexible screen includes a touch module and a display module. The touch module is respectively connected with the display module and the control module; the touch module receives a touch operation of a user on the sub-flexible screen, converts the touch operation into a trigger operation instruction and sends the trigger operation instruction to the control module; the touch module also receives the rhythm information corresponding to the trigger operation instruction sent from the control module and sends the rhythm information to the display module; and the display module displays the rhythm information.

In an embodiment of the present disclosure, the control module includes a receiving module, an analyzing module and a sending module. The analyzing module is respectively connected with the receiving module and the transmitting module; the receiving module receives the trigger operation instruction sent from the touch module; the analyzing module analyzes the trigger operation instruction, generates the rhythm information corresponding to the trigger operation instruction and sends the rhythm information to the sending module; and the transmitting module sends the rhythm information to the touch module.

In an embodiment of the present disclosure, the sound box body further includes a speaker which is positioned on an upper portion of the sound box body and connected with the control module, and the speaker includes an audio amplifier, an audio amplifier cover and an audio amplifier mesh. The audio amplifier is attached to a lower surface of the audio amplifier cover, and the audio amplifier mesh is attached to an upper surface of the audio amplifier cover.

In an embodiment of the present disclosure, the sound box body further includes a wireless fidelity interface connected with the control module.

In an embodiment of the present disclosure, the flexible screen is a Flexible AMOLED.

According to another aspect of the present disclosure, a method for controlling a flexible screen sound box is provided. The method is applied to the flexible screen sound box which includes a sound box body and a flexible screen, the flexible screen is provided on an outer surface of the sound box body and includes at least one sub-flexible screen, and the method includes: analyzing a trigger operation instruction which is obtained by converting a touch operation of a user on the at least one sub-flexible screen; and displaying rhythm information on the at least one sub-flexible screen based on an analyzing result.

According to the technical schemes provided by embodiments of the present disclosure, the flexible screen is provided on the outer surface of the sound box body, so that the rhythm information may be displayed by the at least one sub-flexible screen of the sound box, thereby arousing a purchase desire of young consumers and satisfying requirements of the young consumers for fashion and beauty.

It should be noted that the general descriptions above and the detailed descriptions below are only schematically and explanatory and cannot limit the scope of the present disclosure.

### BRIEF DESCRIPTION OF DRAWINGS

The accompanying drawings which are incorporated into the specification and constituted a part of the specification illustrate embodiments of the present disclosure and explain the principles of the present disclosure along with the specification.

FIG. 1 is a structural schematic diagram of a flexible screen sound box according to an exemplary embodiment of the present disclosure.

FIG. 2 is an exploded schematic diagram of a flexible screen sound box according to an exemplary embodiment of the present disclosure.

FIG. 3 is a schematic diagram of a product of a flexible screen sound box according to an exemplary embodiment of the present disclosure.

FIG. 4 is a flowchart of a method for controlling a flexible screen sound box according to an exemplary embodiment of the present disclosure.

FIG. 5 is a block diagram of a device for controlling a flexible screen sound box according to an exemplary embodiment of the present disclosure.

### DETAILED DESCRIPTION

The technical schemes in embodiments of the present disclosure are clearly and completely described in the following with reference to the accompanying drawings in the embodiments of the present disclosure. Obviously, the described embodiments are only a part of the embodiments of the present disclosure, and not all of the embodiments. All other embodiments obtained by those ordinary skilled in the art based on the embodiments of the present disclosure without creative efforts are within the scope of the present disclosure.

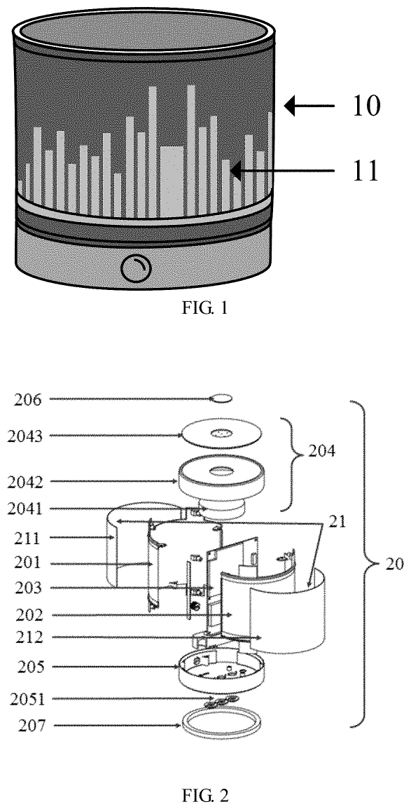

FIG. 1 is a structural schematic diagram of a flexible screen sound box according to an exemplary embodiment of the present disclosure. As shown in FIG. 1, the flexible screen sound box includes a sound box body 10 and a flexible screen 11. The sound box body 10 includes a control module (or can be called “a control circuit”) which is connected with the flexible screen 11. The flexible screen 11 is provided on an outer surface of the sound box body 10 in an arc shape and includes at least one sub-flexible screen configured to receive a control instruction from the control module and display rhythm information based on the control instruction.

In the embodiment of the present disclosure, the sound box body 10 may include the control module connected with the flexible screen 11, and the control module controls the flexible screen 11 by the control instruction. The flexible screen 11 is provided on the outer surface of the sound box body 10 in the arc shape and includes at least one sub-flexible screen configured to receive the control instruction from the control module and display the rhythm information based on the control instruction.

Specifically, the sound box body 10 is a main body portion in a constituting structure of a sound box configured to integrate or carry various corresponding components which is capable of implementing various functions of the sound box. An appearance of the sound box body 10 may be designed into a conventional shape such as a cuboid shape, a cylinder shape, a cone shape, or the like, and may also be designed into an abnormal shape such as an irregular prism shape, a Chinese zodiac shape, a cartoon shape, or the like, which is not limited in the present disclosure.

The control module is connected with the at least one sub-flexible screen of the flexible screen 11 by a signal line. When the at least one sub-flexible screen receives the control instruction from the control module, the at least one sub-flexible screen may display rhythm information based on the control instruction. Further, the control module may be a microcontroller such as a single chip computer, ARM (Advanced RISC Machines), or the like, and may also be other microprocessors, which is not limited in the present disclosure.

The flexible screen 11 may be a flexible screen made of a flexible material having characteristics of flexibility and deformability. Preferably, the flexible screen 11 is a Flexible AMOLED with a relatively fast reacting speed, a relatively high contrast and a relatively wide gamut range.

Further, the flexible screen 11 is provided on the outer surface of the sound box body 10 in the arc shape, and the number of the flexible screens 11 may be one, two or more; which is not limited in the present disclosure. Specifically, when the flexible screen 11 includes only one flexible screen, the flexible screen may be designed into any shape such as a parallelogram, a sector, an irregular figure, etc., according to a shape of the sound box body 10; and the flexible screen may also perform a partition display according to needs. For example, the flexible screen may be divided into two or a plurality of regions;

each region displays different contents of one of identical rhythm information and different rhythm information, and therefore, a multi-page display of the rhythm information and the partition display of the rhythm information are realized. When the flexible screen 11 includes two sub-flexible screens (i.e., a first sub-flexible screen and a second sub-flexible screen), the first sub-flexible screen and the second sub-flexible screen are respectively provided on the outer surface of the sound box body 10 in the arc shape. The first sub-flexible screen and the second sub-flexible screen may display one of an identical content and different contents, or may display one of the identical rhythm information and different rhythm information by partitioning, which is not limited in the present disclosure. When the flexible screen 11 includes a plurality of sub-flexible screens, these sub-flexible screens are respectively provided on the outer surface of the sound box body 10 in the arc shape; and a user may switch pages by a sliding operation, a clicking operation, etc. as needed, thus improving usability of the sound box and further enhancing user experience. It should be noted that, when the flexible screen 11 includes two sub-flexible screens or the plurality of sub-flexible screens, these sub-flexible screens may be bonded to the outer surface of the sound box body 10 by using a colorless and transparent optical glue with a good bonding strength, or may be connected with the outer surface of the sound box body 10 by using a rotatable shaft, buckles, or the like, which is not limited in the present disclosure. In addition, when the flexible screen 11 includes two sub-flexible screens or a plurality of sub-flexible screens, these sub-flexible screens may be designed into any shape such as a parallelogram, sector, irregular figure, etc., according to the shape of the sound box body 10.

According to the technical schemes provided by the embodiments of the present disclosure, the flexible screens are provided on the outer surface of the sound box body in the arc shape, so that the rhythm information may be displayed by at least one sub-display of the sound box, thereby arousing a purchase desire of young consumers and satisfying requirements of the young consumers for fashion and beauty.

In another embodiment of the present disclosure, the flexible screen and the at least one sub-flexible screen may be provided on the outer surface of the sound box body 10 in one of the arc shape and an non-arc shape respectively. Because the flexible screen is flexible and deformable, the flexible screen may change with the shape of the sound box body 10 and may be provided in any shape, and details are not described herein again. In another embodiment of the present disclosure, the at least one sub-flexible screen receives the control instruction of the control module and displays pictures or notes that change with rhythm based on the control instruction. Specifically, after receiving the control instruction send from the control module, the at least one sub-flexible screen, under a control of the control instruction, may display different pictures or notes according to the changes of the rhythm.

In another embodiment of the present disclosure, the at least one sub-flexible screen includes a first sub-flexible screen and a second sub-flexible screen. The first sub-flexible screen is provided on a portion of the outer surface of the sound box body in the arc shape, the second sub-flexible screen is provided on another portion of the outer surface of the sound box body in the arc shape, and the control module controls the first sub-flexible screen and the second sub-flexible screen, respectively.

Specifically, the first sub-flexible screen and the second sub-flexible screen may be provided on the outer surface of the sound box body 10 in the arc shape, i.e., in a closed state (filling a whole outer surface of the sound box body 10), or may be provided on a portion of the outer surface of the sound box body 10 in the arc shape, i.e., in an unclosed state (not filling the whole outer surface of the sound box body 10), which is not limited in the present disclosure. It should be noted that, the at least one sub-flexible screen may be provided separately from the sound box body 10, for example, the at least one sub-flexible screen may be provided on a top of the sound box body 10 by taking a closed ring shape, or may be spread a display shape such as a flat shape, concave shape, wave shape etc., on a side of the sound box body 10.

The at least one sub-flexible screen includes the first sub-flexible screen and the second sub-flexible screen, the first sub-flexible screen and the second sub-flexible screen may be bonded together by using an optical glue, or may be connected with each other by a rotatable shaft, a buckle, or the like, which is not limited in the present disclosure. It should be noted that, the first sub-flexible screen and the second sub-flexible screen may also be two independent flexible screens without any connection. In addition, the first sub-flexible screen and the second sub-flexible screen may have identical or different size and shape, which is not limited in the present disclosure.

Further, the first sub-flexible screen is provided on a portion of the outer surface of the sound box body 10 in the arc shape, the second sub-flexible screen is provided on the other portion of the outer surface of the sound box body 10 in the arc shape, such that the flexible screens present a closed ring shape; or, the first sub-flexible screen is provided on a portion of the outer surface of the sound box body 10 in the arc shape, the second sub-flexible screen is provided on another portion of the outer surface of the sound box body 10 in the arc shape, such that the flexible screens present a unclosed ring shape.

In another embodiment of the present disclosure, the sound box body includes a first sound box housing and a second sound box housing. Specifically, the sound box body 10 may be constituted by both of the first sound box housing and the second sound box housing to facilitate assembly and disassembly. Further, the at least one sub-flexible screen may be provided on an outer surface of at least one of the first sound box housing and the second sound box housing in the arc shape. It should be noted that, the sound box body may include a plurality of sound box housings, such as three, four, etc., which is not limited in the present disclosure.

In another embodiment of the present disclosure, the at least one sub-flexible screen includes a touch module (or can be called “a touch circuit”) and a display module (or can be called “a display circuit”). The touch module is connected with the display module and the control module respectively. The touch module receives a touch operation of a user on the at least one sub-flexible screen, converts the touch operation into a trigger operation instruction and sends the trigger operation instruction to the control module. The touch module also receives the rhythm information corresponding to the trigger operation instruction sent from the control module and sends the rhythm information to the display module. The display module displays the rhythm information.

Specifically, the at least one sub-flexible screen may include a touch module and a display module connected with the touch module. In addition, the touch module may be connected with the control module. When the touch operation of the user on the at least one sub-flexible screen (such as slide, click, drag, etc.) is received, the touch module converts the touch operation into the trigger operation instruction and sends the trigger operation instruction to the control module. Further, the touch module receives the rhythm information corresponding to the trigger operation instruction sent from the control module and sends the rhythm information to the display module, such that the display module displays the rhythm information. The rhythm information may include, but is not limited to, a musical rhythm such as a rectangular columnar pattern, a visual effect, video, text, symbol, pattern; etc., followed by a water wave and a musical line, and a format of the rhythm information may include, but is not limited to, .mp4, .wma, .avi, .ogg, .mkv, etc.

In another embodiment of the present disclosure, the control module includes a receiving module (or can be called “a receiving circuit”), an analyzing module (or can be called “an analyzing circuit”) and a sending module (or can be called “a sending circuit”). The analyzing module is connected with the receiving module and the sending module respectively. The receiving module receives the trigger operation instruction sent from the touch module. The analyzing module analyzes the trigger operation instruction, generates the rhythm information corresponding to the trigger operation instruction and sends the rhythm information to the sending module. The sending module sends the rhythm information to the touch module.

Specifically, the control module may include a receiving module, an analyzing module connected with the receiving module and a sending module connected with the analyzing module. When the trigger operation instruction sent from the touch module is received, the receiving module sends the trigger operation instruction to the analyzing module. The analyzing module analyzes the trigger operation instruction, generates the rhythm information corresponding to the trigger operation instruction and sends the rhythm information to the sending module. Further, the sending module sends the received rhythm information to the touch module.

In another embodiment of the present disclosure, the sound box body further includes a speaker which is positioned on an upper portion of the sound box body and connected with the control module. The speaker includes an audio amplifier, an audio amplifier cover and an audio amplifier mesh. The audio amplifier is attached to a lower surface of the audio amplifier cover, and the audio amplifier mesh is attached to an upper surface of the audio amplifier cover.

Specifically, the sound box body 10 may also include a speaker which is positioned on the upper portion of the sound box body 10 and connected with the control module. The speaker includes the audio amplifier, the audio amplifier cover and the audio amplifier mesh. The audio amplifier is attached to the lower surface of the audio amplifier cover, and the audio amplifier mesh is attached to the upper surface of the audio amplifier cover. It should be noted that, the number of the speaker may be one, two or more. In addition, the speaker may also be provided on one of a lower portion of the sound box body 10 and a side of the sound box body 10, which is not limited in the present disclosure.

Alternatively, according to another embodiment, the sound box body further includes a Wireless Fidelity (WiFi) interface which is connected with the control module.

Specifically, the sound box body 10 may further include a WiFi interface connected with the control module, the control module realizes the control of the download on the rhythm information by controlling the WiFi interface. The WiFi interface as described above is not limited in the present disclosure, but the present disclosure may further include other interfaces, such as a Bluetooth, a Universal Serial Bus (USB) interface etc. Further, in a region covered by WiFi, the WiFi interface may correct time information of the flexible screen sound box automatically.

In addition, the sound box body 10 may further include a storage module (or can be called “a storage circuit”) connected with the control module and configured to store the rhythm information. The storage module may be an internal one (for example, a NAND Flash Memory) or an external one (for example, a Secure Digital card), or a combination of the internal one and the external one, which is not limited in the present disclosure.

FIG. 2 is an exploded schematic diagram of a flexible screen sound box according to an exemplary embodiment of the present disclosure. As shown in FIG. 2, the flexible screen sound box includes a sound box body 20 and a flexible screen 21.

Specifically, the sound box body 20 includes a first sound box housing 201 and a second sound box housing 202, a main board 203 located inside the sound box body 20, a speaker 204 located on a top of the sound box body 20 and a lower cover 205 located at a bottom of the sound box body 20. The speaker 204 includes an audio amplifier 2041, an audio amplifier cover 2042 located on the audio amplifier 2041 and an audio amplifier mesh 2043 located at a center of an upper surface of the audio amplifier cover 2042. The audio amplifier 2041 is attached to a lower surface of the audio amplifier cover 2042. A button 2051 is provided on the lower cover 205.

In addition, the sound box body 20 further includes a trim board 206 located on the top of the audio amplifier mesh 2043 and a cushion ring 207 located at the bottom of the lower cover 205. The trim board 206 may protect the audio amplifier mesh 2043 from dust intrusion and may also decorate a top surface of the sound box body 20, that is to say, an upper surface of the trim board 206 may be painted or graffiti, so that the appearance of the flexible screen sound box is relatively beautiful and fashionable, and thus improving customer attractiveness. The cushion ring 207 may prevent the bottom of the flexible screen sound box from being damaged.

It should be noted that, the speaker 204 is not limited to be disposed on the top of the sound box body 20 as described above, but may be provided at any position of the sound box body 20, such as at the bottom or the side of the sound box body 20, as appropriate.

The flexible screen 21 includes a first sub-flexible screen 211 and a second sub-flexible screen 212, the first sub-flexible screen 211 is provided on a portion of an outer surface of the first sound box housing 201 in an arc shape, and the second sub-flexible screen 212 is provided on another portion of the outer surface of the second sound box housing 202 in the arc shape. It should be noted that, the number of the flexible screen 21 is not limited to two as described above, but may be one or more. In addition, it should be noted that, the flexible screen 21 may be a touch flexible screen, i.e., the user may control the rhythm information by an operation of sliding fingers, clicking fingers and dragging fingers, etc. on the flexible screen 21.

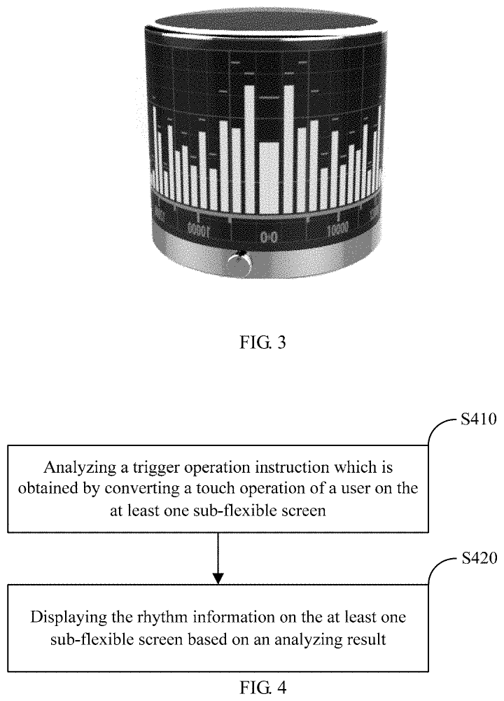

FIG. 3 is a schematic diagram of a product of a flexible screen sound box according to an exemplary embodiment of the present disclosure. As shown in FIG. 3, the flexible screen sound box is composed of a sound box body and a flexible screen, a control module in the sound box body controls the flexible screen provided on an outer surface of the sound box body to display rhythm information by using a control instruction.

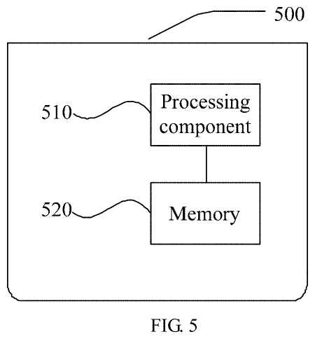

FIG. 4 is a flowchart of a method for controlling a flexible screen sound box according to an exemplary embodiment of the present disclosure. The method is applied to the flexible screen sound box which includes a sound box body and a flexible screen, and the flexible screen is provided on an outer surface of the sound box body in an arc shape and includes at least one sub-flexible screen. As shown in FIG. 4, the method includes:

S410: analyzing a trigger operation instruction which is obtained by converting a touch operation of a user on the at least one sub-flexible screen.

In the embodiment of the present disclosure, a control module in the sound box body receives the trigger operation instruction which is converted from the touch operation of the user on the at least one sub-flexible screen and analyzes the trigger operation instruction to acquire rhythm information corresponding to the trigger operation instruction.

S420: displaying the rhythm information on the at least one sub-flexible screen based on an analyzing result.

In the embodiment of the present disclosure, after the rhythm information corresponding to the trigger operation instruction is acquired, the rhythm information may be displayed on the at least one sub-flexible screen.

According to the technical schemes provided by the embodiments of the present disclosure, the flexible screens are provided on the outer surface of the sound box body in the arc shape, so that the rhythm information may be displayed by the at least one sub-flexible screen of the sound box, Thereby arousing a purchase desire of young consumers and satisfying requirements of the young consumers for fashion and beauty.

FIG. 5 is a block diagram of a device 500 for controlling a flexible screen sound box according to an exemplary embodiment of the present disclosure.

Referring to FIG. 5, the device 500 includes a processing component 510, the device 500 further includes one processor or a plurality of processors and a memory resource which is represented by a memory 520 configured to store an instruction, such as an application, executed by the processing component 510. The application stored in the memory 520 may include one or more modules, each of which corresponds to a set of instructions. Additionally, the processing component 510 is configured to execute the instruction to execute the above described method for controlling the flexible screen sound box.

The device 500 may further include a power supply component configured to manage power supply of the device 500, a wired or wireless network interface configured to connect the device 500 to a network and an input/output (I/O) interface. The device 500 may be operated based on an operating system stored in the memory 520, such as Windows Server™, Mac OS X™, Unix™, Linux™, FreeBSD™, and the like.

There is provided a non-temporary computer readable storage medium, when the instruction in the storage medium is executed by a processor of the above described device 500, the above described device 500 can execute a method for controlling a flexible screen sound box which is applied to a flexible screen sound box. The flexible screen sound box includes a sound box body and a flexible screen; the flexible screen is provided on an outer surface of the sound box body in an arc shape and includes at least one sub-flexible screen. The method includes: analyzing a trigger operation instruction which is obtained by converting a touch operation of a user on the at least one sub-flexible screen; and displaying rhythm information on the at least one sub-flexible screen based on an analyzing result.

Those ordinary skilled in the art may appreciate that the units and algorithm steps of the various examples described in connection with the embodiments disclosed herein may be implemented by electronic hardware or a combination of computer software and electronic hardware. Whether these functions are performed by hardware or software depends on the specific application and design constraints of the technical schemes. A person skilled in the art may use different methods to implement the described functions for each particular application, but such implementation should not be considered to be beyond the scope of the present disclosure.

A person skilled in the art may clearly understand that for the convenience and brevity of the description, the specific working processes of the systems, the devices and the units described above may refer to the corresponding processes in the foregoing method embodiments, and details are not described herein again.

In the several embodiments provided by the present disclosure, it should be understood that the disclosed systems, devices and methods may be implemented in other manners. For example, the device embodiments described above are merely illustrative.

For example, a division of the units is only a logical function division. In actual implementation, there may be another division manner, for example, a plurality of units or components may be combined or integrated into another system, or some features may be ignored or not executed. In addition, one of a coupling, a direct coupling and a communication connection shown or discussed herein may be one of an indirect coupling and communication connection of some interfaces, devices or units, and may be electrical, mechanical or otherwise.

The unit described as a separate component may or may not be physically separated, and the component displayed as the unit may or may not be a physical unit, i.e., may be located in one place, or may be distributed to a plurality of network units. Some or all of the units may be selected according to actual needs to achieve the purposes of the schemes of the embodiments.

In addition, each functional unit in each embodiment of the present disclosure may be integrated into one processing unit, or each unit may exist physically and separately, or two or more units may be integrated into one unit.

The functions may be stored in the computer readable storage medium if implemented in a form of software functional units and sold or used as a standalone product. Based on such understanding, the technical schemes of the present disclosure may be embodied in a form of a software product in one of essential, a part contributing to the prior art and a part of the technical schemes, the computer software product is stored in a storage medium, including several instructions to enable a computer device (which may be a personal computer, server, or network device, etc.) to perform all or part of steps of methods described in various embodiments of the present disclosure. The above described storage medium includes any medium that may store program check code, such as a USB stick, mobile hard drive, Read-Only Memory (ROM), Random Access Memory (RAM), magnetic disc or optical disk etc.

The foregoing descriptions are merely specific embodiments of the present disclosure, but the protection scope of the present disclosure is not limited hereto. Any modifications or replacements which are easily occurred to those skilled in the technical art based on the technical scope disclosed in the present disclosure are all fall within the protection scope of the present disclosure. Therefore, the protection scope of the present disclosure should be referred to the protection scope of the claims.

What is claimed is:

1. A flexible screen sound box, comprising a sound box body and a flexible screen,
wherein the sound box body comprises a control module connected with the flexible screen; and
the flexible screen is provided on an outer surface of the sound box body, and comprises at least one sub-flexible screen configured to receive a control instruction of the control module and display rhythm information based on the control instruction.

2. The flexible screen sound box of claim 1, wherein the at least one sub-flexible screen receives the control instruction from the control module and displays pictures or notes that change with rhythm based on the control instruction.

3. The flexible screen sound box of claim 2, wherein the at least one sub-flexible screen comprises a first sub-flexible screen and a second sub-flexible screen; the first sub-flexible screen is provided on a portion of the outer surface of the sound box body, the second sub-flexible screen is provided on another portion of the outer surface of the sound box body, and the control module controls the first sub-flexible screen and the second sub-flexible screen, respectively.

4. The flexible screen sound box of claim 3, wherein the sound box body comprises a first sound box housing and a second sound box housing.

5. The flexible screen sound box of claim 1, wherein each sub-flexible screen of the at least one sub-flexible screen comprises a touch module and a display module;
the touch module is respectively connected with the display module and the control module;
the touch module receives a touch operation of a user on the sub-flexible screen, converts the touch operation into a trigger operation instruction and sends the trigger operation instruction to the control module;
the touch module also receives the rhythm information corresponding to the trigger operation instruction sent from the control module and sends the rhythm information to the display module; and
the display module displays the rhythm information.

6. The flexible screen sound box of claim 5, wherein the control module comprises a receiving module, an analyzing module and a sending module;
the analyzing module is respectively connected with the receiving module and the sending module;
the receiving module receives the trigger operation instruction sent from the touch module;
the analyzing module analyzes the trigger operation instruction, generates the rhythm information corresponding to the trigger operation instruction and sends the rhythm information to the sending module; and
the sending module sends the rhythm information to the touch module.

7. The flexible screen sound box of claim 1, wherein the sound box body further comprises a speaker which is positioned on an upper portion of the sound box body and connected with the control module; the speaker comprises an audio amplifier, an audio amplifier cover and an audio amplifier mesh, the audio amplifier is attached to a lower surface of the audio amplifier cover, and the audio amplifier mesh is attached to an upper surface of the audio amplifier cover.

8. The flexible screen sound box of claim 7, wherein the sound box body further comprises a wireless fidelity interface connected with the control module.

9. The flexible screen sound box of claim 1, wherein the flexible screen is a Flexible AMOLED.

10. A method for controlling a flexible screen sound box, wherein the method is applied to the flexible screen sound box which comprises a sound box body and a flexible screen, the flexible screen is provided on an outer surface of the sound box body and comprises at least one sub-flexible screen, and the method comprises:
analyzing a trigger operation instruction which is obtained by converting a touch operation of a user on the at least one sub-flexible screen; and
displaying rhythm information on the at least one sub-flexible screen based on an analyzing result.
